(19) United States
(12) Patent Application Publication
(10) Pub. No.: US 2009/0227124 A1
(43) Pub. Date: Sep. 10, 2009

(54) Electrical connector

(75) Inventors: David W. Mendenhall, Naperville, IL (US); Hecham K. Elkhatib, Aurora, IL (US); Alan A. Raclawski, Schaumburg, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Cinch Connectors, Inc., Lombard, IL (US)

(21) Appl. No.: 12/074,812

(22) Filed: Mar. 6, 2008

(51) Int. Cl. H01R 12/00; H01R 13/62; H01R 13/40; H01R 13/648

(52) U.S. Cl. 439/68; 439/331; 439/625

(57) ABSTRACT

The electrical connector may include an insulative housing and a support member. The housing may include a first surface, a second surface, a first side, and at least one aperture disposed from the first surface to the second surface. The support member may be mounted to the first side to provide rigidity to the insulative housing. The support member may include a mounting latch to attach the support member to the housing. The support member may also include an anchor tab which may be soldered to a component, such as, a printed circuit board.

### BACKGROUND

An electrical connector including a housing and electrical contacts is used for establishing electrical communication between electrical components, such as between an IC chip package and a printed circuit board.

### BRIEF SUMMARY

In one embodiment, an electrical connector comprises an insulative housing and a support member. The housing may include a first surface, second surface, a first side, and at least one aperture disposed from the first surface to the second surface. The support member may be mounted to the first side to provide rigidity to the insulative housing. The electrical connector may further comprise an electrical contact disposed within the aperture for establishing electrical communication from the first surface to the second surface, such that the contact may electrically connect two electrical components such as an IC chip package and a printed circuit board. The support member may be stiffer than the insulative housing.

In one embodiment, the support member may include a first mounting latch having upper and lower tabs that are received by a first latch slot on the first surface housing and a second latch slot on the second surface of the housing, respectively, such that the tabs are retained therein to secure the support member to the first side. The support member may also include a first anchor tab.

In another embodiment, a support member for an electrical connector may comprise a center beam and a first mounting latch. The mounting latch may be a clamping device. The mounting latch may include upper and lower tabs configured to be received by respective slots on an insulative housing of an electrical connector to mount the support member thereto.

### BRIEF DESCRIPTION OF THE DRAWINGS

FIG. 1 is a perspective view of an electrical connector.

FIG. 2 is a perspective view of a support member of the electrical connector of FIG. 1.

FIG. 3 is a top view of the electrical connector of FIG. 1.

FIG. 4 is a bottom view of the electrical connector of FIG. 1.

FIG. 5 is a side view of the electrical connector of FIG. 1.

FIG. 6 is the same view as FIG. 3, but the support members have been removed.

FIG. 7 is the same view as FIG. 4, but the support members have been removed.

FIG. 8 is a top view of the support member of FIG. 2.

FIG. 9 is a bottom view of the support member of FIG. 2.

FIG. 10 is front view of the support member of FIG. 2.

FIG. 11 is a side view of the support member of FIG. 2.

FIG. 12 is a perspective cross-sectional view along line 12-12 of FIG. 1.

FIG. 13 is a cross-sectional view along line 12-12 of FIG. 1.

FIG. 14 is a perspective cross-sectional view of an aperture and contact of the electrical connector of FIG. 1.

FIG. 15 is a partial cross-sectional view along line 15-15 of FIG. 3.

FIG. 16 is a partial cross-sectional view along line 16-16 of FIG. 6.

FIG. 17 is the same view as FIG. 16 but the insulative housing has bowed further.

### DESCRIPTION OF THE DRAWINGS

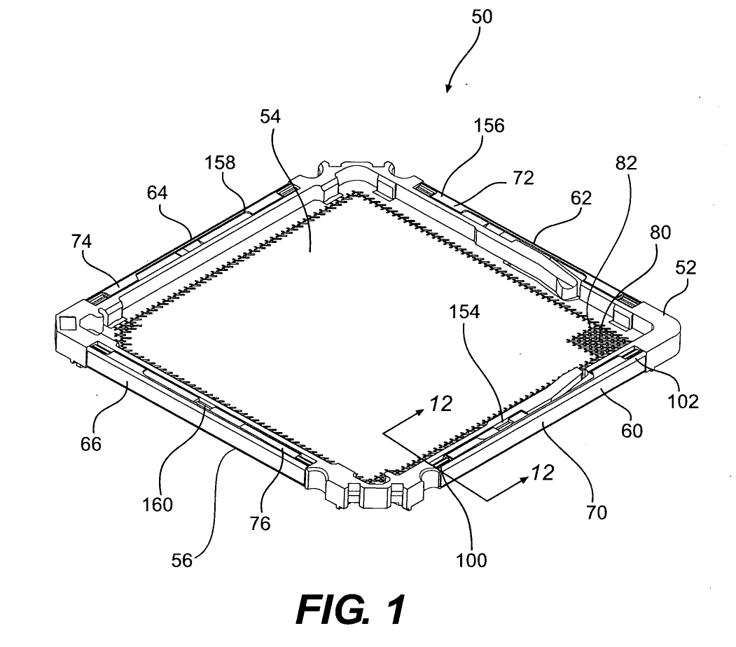

Referring to FIG. 1, there is shown an electrical connector 50 comprising an insulative housing 52. The insulative housing 52 may include a first surface 54, a second surface 56, and first, second, third, and fourth sides 60, 62, 64, 66. The electrical connector 50 may include a first support member 70, a second support member 72, a third support member 74, and a fourth support member 76 mounted to the first, second, third, and fourth sides 60, 62, 64, 66, respectively, of the insulative housing 52. The insulative housing 52 may include a plurality of apertures 80 disposed from the first surface 54 to the second surface 56 and a plurality of electrical contacts 82 disposed in respective apertures 80. The electrical contacts may establish an electrical connection between the first and second surfaces 54, 56 such that the electrical connector 50 may establish electrical communication between two electrical components when the electrical connector 50 is included in an electrical assembly. For example, the electrical connector 50 could establish an electrical connection between an IC chip package disposed against the first surface 54 and a printed circuit board (PCB) disposed against the second surface 56.

The support members 70, 72, 74, 76 may server as strain-relief and straightening components for the electrical connector 50. The support members 70, 72, 74, 76, by nature of their mounting to the insulative housing 52, may restrain deflection of the housing 52 and provide rigidity against the effects of either bow within the housing 52 or from an external force that may be applied to the connector 50 or housing 52. The support members 70, 72, 74, 76 may thereby ensure that the electrical contacts disposed within the apertures 80 are not dislocated from their positions by deflection, bow, or bending of the insulative housing 52. By helping to constrain the insulative housing 52 substantially within a single plane, the support members 70, 72, 74, 76 assist in maintaining the contacts within a substantially uniform plane of distribution. This helps ensure that the contacts remain in contact with other electrical components that may be disposed against the first or second surfaces 54, 56 of the housing 52 when the electrical connector 50 is assembled in an electrical assembly.

The support members 70, 72, 74, 76 may be used with a variety of insulative housings. The insulative housing 52 of the electrical connector 50 may be of various configurations that could benefit from the support of the support members 70, 72, 74, 76. For example the insulative housing may be any appropriate housing disclosed in U.S. Patent Publication No. 2007-0178719 A1 (U.S. patent application Ser. No. 11/634,593), which is incorporated herein by reference in its entirety.

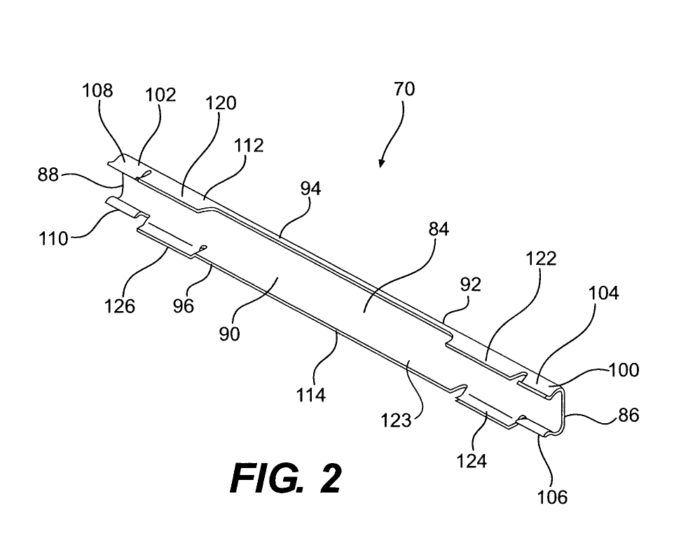

The support members 70, 72, 74, 76 may be substantially similar. Accordingly, only the first support member 70 will be described in detail. Referring to FIG. 2, the first support member 70 may include a center beam 84 that extends between the first distal end 86 and the second distal end 88 of the support member 70. The support member 70 may include an inside surface 90, an outside surface 92, an upper edge 94, and a lower edge 96. The support member 70 may include a first mounting latch 100 disposed proximate the first distal 86 end a second mounting latch 102 disposed proximate the second distal end 88. The first mounting latch 100 and the second mounting 102 latch may be clamping devices. The first mounting latch 100 may include an upper tab 104 and a lower tab 106 that extend away from the inside surface 90 of the support member 70. The second mounting latch 102 may also include upper and lower tabs 108, 110.

The support member 70 may include an upper wall 112 that extends from the upper edge 94 and a lower wall 114 that extends from the lower edge 96. Both the upper and lower walls 112, 114 may extend away from the inside surface 90 of the support member 70. The upper wall 112 may include a first portion 120 and a second portion 122 disposed proximate the upper tabs 104, 108 of the first and second mounting latches 100, 102, respectively. The lower wall 114 may be comprised of a portion 123 that is substantially centered on the support member 70.

Referring to FIG. 2, the support member 70 further comprises a first anchor tab 124 and a second anchor tab 126. The anchor tabs 124, 126 may be disposed on the lower edge 96 and extend generally away from the inside surface 90 of the center beam 84. The first anchor tab 124 may be disposed between the first mounting latch 100 and the lower wall 114, and the second anchor tab 126 may be disposed between the second mounting latch 102 and the lower wall 114.

In other embodiments, the mounting latches, anchor tabs, and walls may be arranged differently on the support member. In one embodiment, the mounting latches may not be disposed at the distal ends of the support member. In another embodiment, the anchor tabs may be located outside of the mounting latches. In another embodiment, the support member may include only a single anchor tab or a single mounting latch. In another embodiment, the support member may include more than two mounting latches or more than two anchor tabs. In yet another embodiment, the support member may not include upper or lower walls.

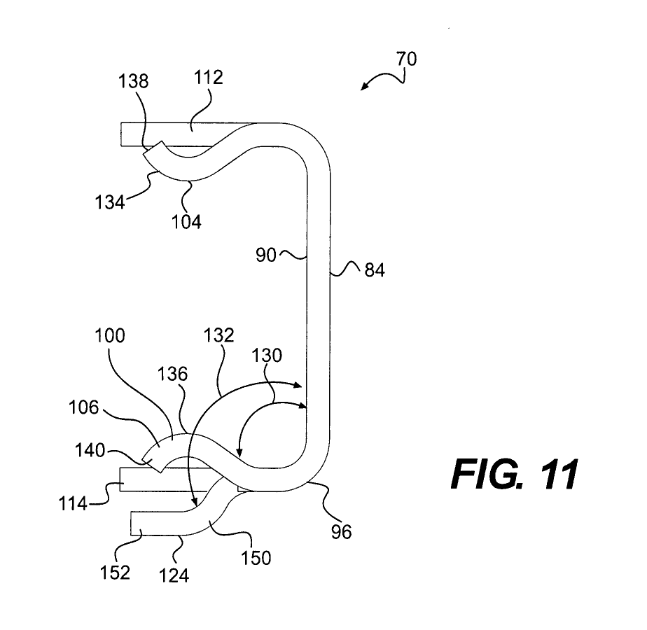

Referring to FIG. 11, the upper and lower walls 112, 114, the mounting latch 100, and the anchor tab 124 may extend away from the center beam 84 in different planes. The upper and lower walls 112, 114 may be substantially parallel to the center beam 84. The mounting latch 100 may extend to the inside of the upper and lower walls 112, 114 such that the mounting latch 100 is generally disposed at an acute angle 130 to the inside surface 90 of the center beam 84. The anchor tab 124 may extend to the outside of the lower wall 114 such that the anchor tab 124 is generally disposed at an obtuse angle 132 to the inside surface 90 of the center beam 84.

Referring to FIG. 2, the first mounting latch 100 may be a clamping device. The upper and lower tabs 104, 106 may be disposed at angle with respect to the center beam 84 and with respect to each other. Referring to FIG. 11, the upper and lower tabs 104, 106 may converge towards each other as they extend out from the center beam 84. The upper and lower tabs 104, 106 may include respective curved surfaces 134, 136 disposed proximate their respective distal ends 138, 140 wherein the curved surfaces 134, 136 of the tabs 104, 106 may convexly face each other. At the respective distal ends 138, 140 of the tabs 104, 106, the upper and lower tabs 104, 106 may curve back away from each other. The second mounting latch 102 may be configured similarly to the first mounting latch 100.

Referring to FIG. 11, the first anchor tab 124 may include a first portion 150 and a second portion 152. The first portion 150 may extend from the lower edge 96 of the support member 70 at a generally obtuse angle 132 to the inside surface 90 of the center beam 84. The second portion 152 may be attached to the first portion 150 and extend substantially perpendicularly to the center beam 84. The second anchor tab 126 may be configured similarly to the first anchor tab 124.

Referring to FIG. 1, the support member 70 may be secured to the first side 60 of the insulative housing 52 by the first and second mounting latches 100, 102. The first side 60 may include a recessed area 154 to receive the support member 70. The second side 62, the third side 64, and the fourth side 66 may also include recessed areas 156, 158, 160 to receive the second, third, and fourth support members 72, 74, 76, respectively. The first, second, third, and fourth recesses 154, 156, 158, 160 may be similarly configured.

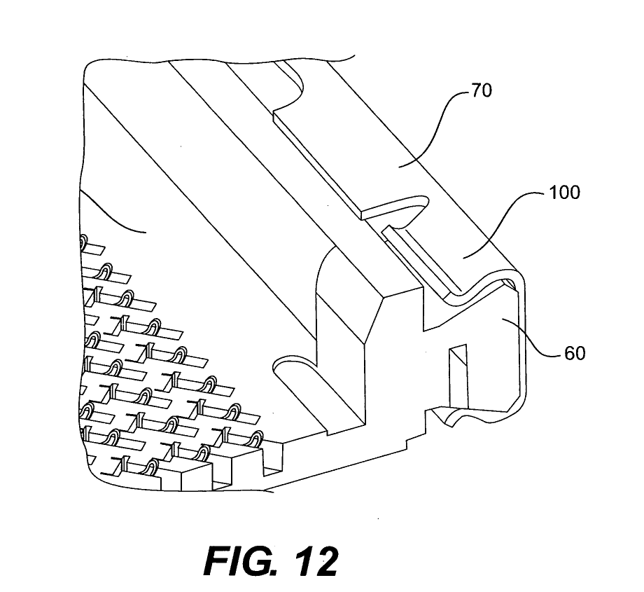

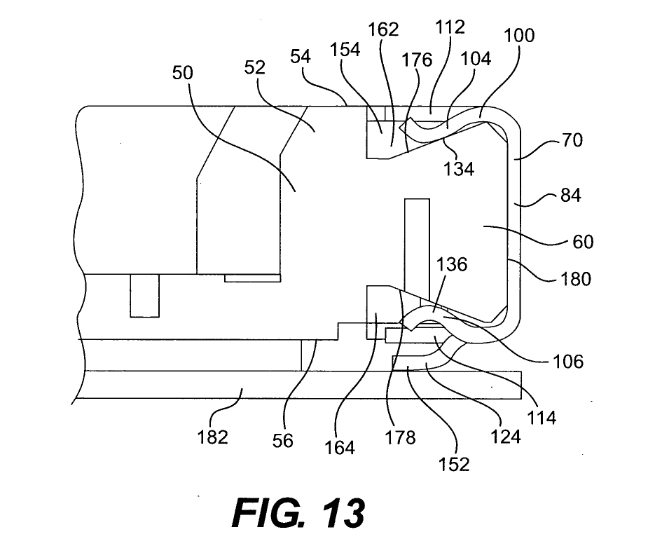

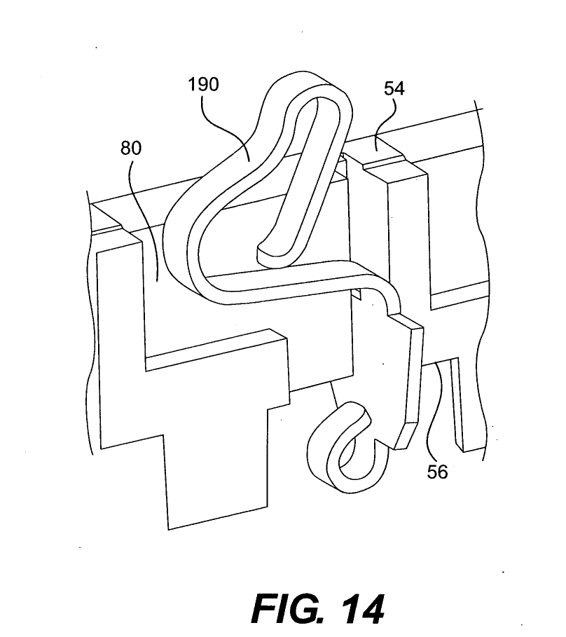

Referring to FIG. 12, the first mounting latch 100 may be a clamping device that clamps onto the first side 60 of the insulative housing 52. Referring to FIG. 13, the electrical connector 50 may include a first latch slot 162 on the first surface 54 of the housing and a second latch slot 164 on the second surface 56 of the housing 52, which correspond to the first mounting latch 100 of the support member 70. The latch slot 162 may be disposed within the recess 154. The first latch slot 162 may be configured to receive the upper tab 104 and the second latch slot 164 may be configured to receive the lower tab 106. The tabs 104, 106 are retained therein to secure the first support member 70 to the first side 60 of the housing 52.

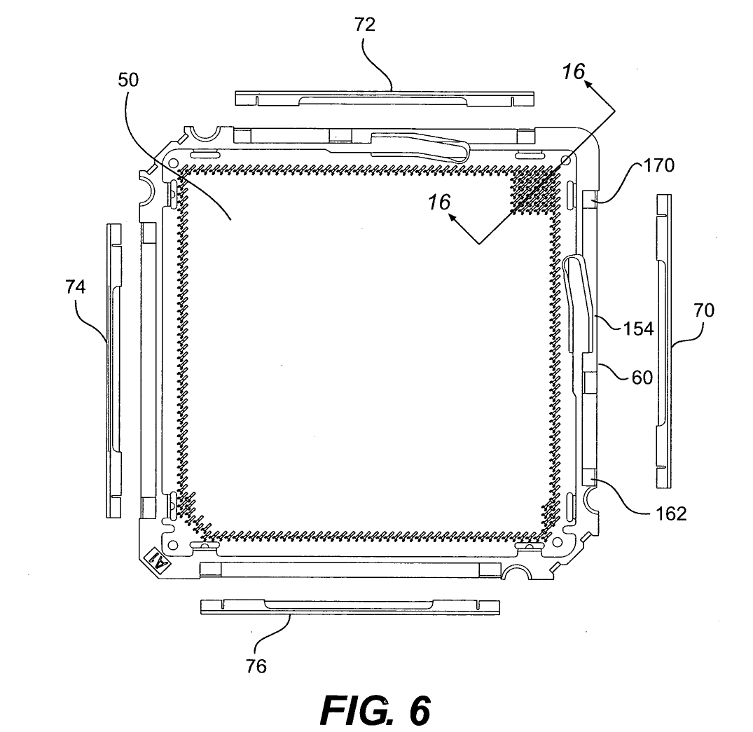

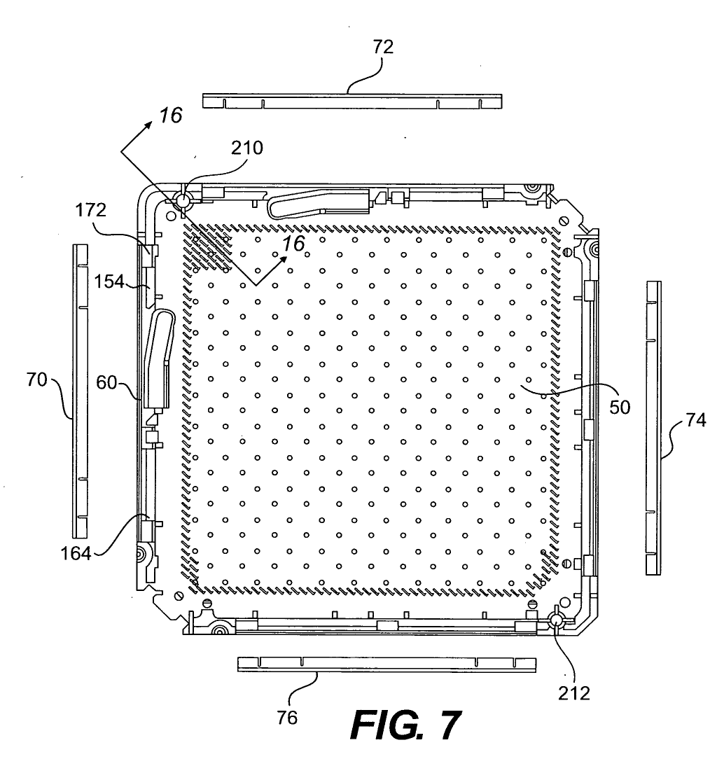

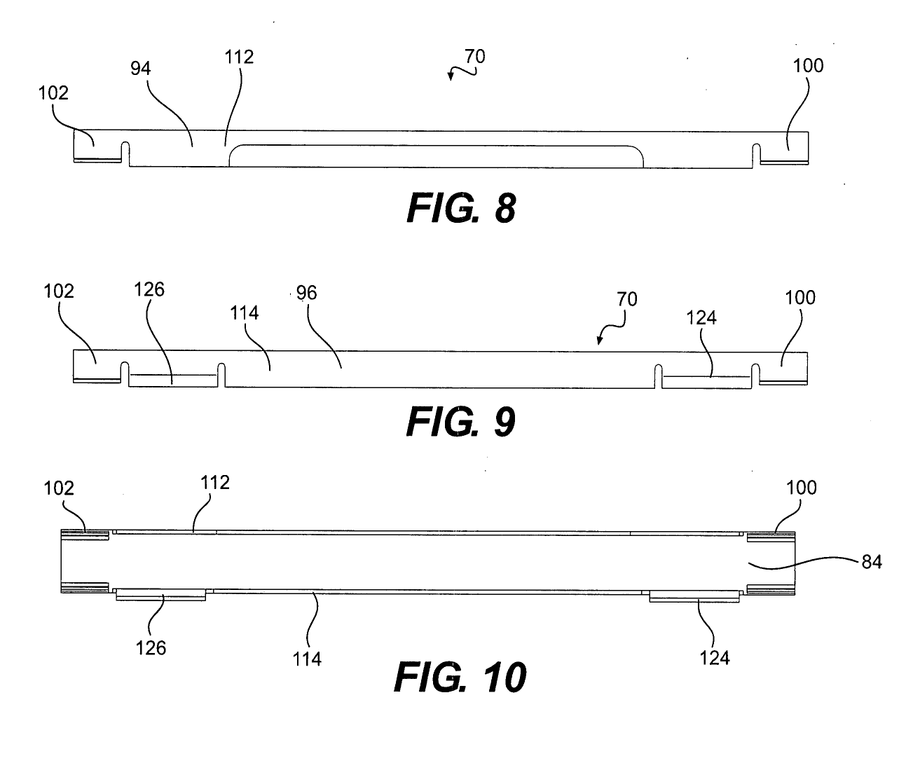

Referring to FIGS. 6 and 7, the second mounting latch 102 may also be a clamping device that may clamp onto the first side 60 of the housing 52. The housing 52 may include a third latch slot 170 and fourth latch slot 172 configured to receive the upper and lower tabs of the second mounting latch, respectively, and retain them therein. The second mounting latch 102 may thereby help secure the first support member 70 to the first side 60.

Referring to FIG. 13, when the support member 70 is mounted to the first side 60, the support member 70 may fit snuggly onto the insulative housing 52. The first and second latch slots 162, 164 may include respective angled walls 176, 178, which extend into the first and second surfaces 54, 56, respectively, of the housing 52. When the support member 70 is mounted to the housing 52, the curved surfaces 134, 136 of the upper and lower tabs 104, 106 may be disposed proximate to the first and second angled walls 176, 178, respectively. The center beam 84 may be substantially parallel to the outside surface 180 of the first side 60.

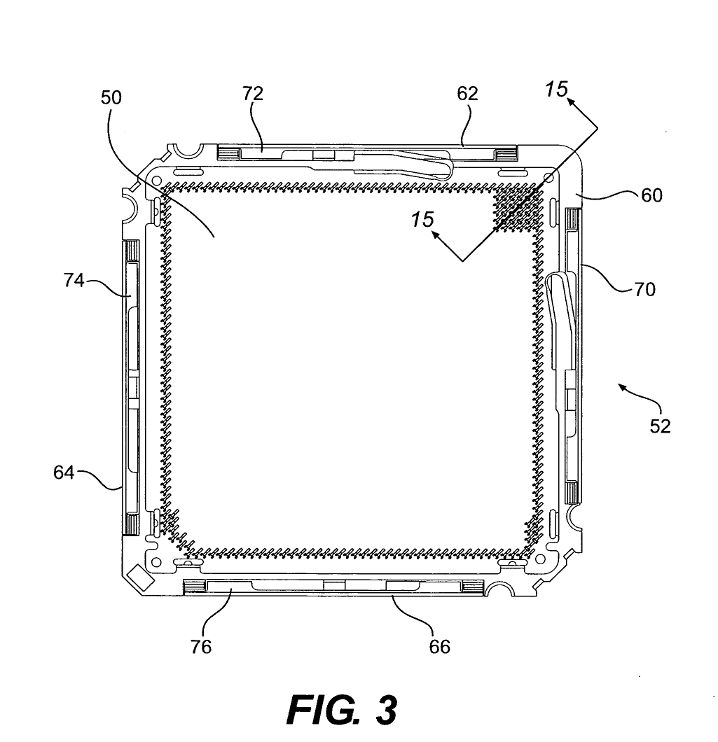

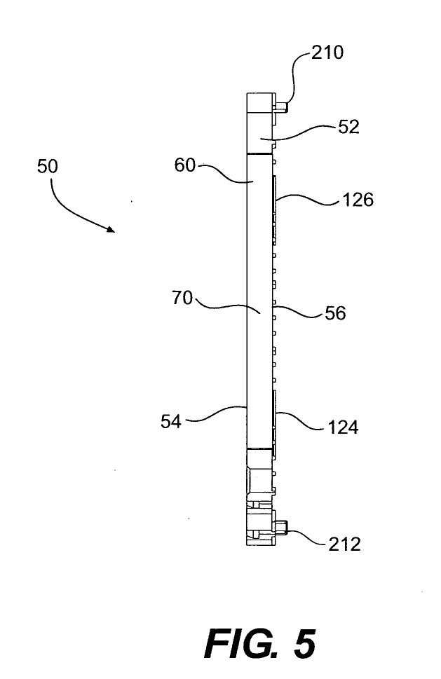

Referring to FIG. 5, the support member 70 may be fitted to the insulative housing 52 so as to not substantially affect the profile of the housing 52. The support member 70 may be substantially flush with the first and second surfaces 54, 56 of the housing 52. Referring to FIG. 3, the support members 70, 72, 74, 76, may be substantially flush with their respective sides 60, 62, 64, 66.

Referring to FIG. 5, the anchor tabs 124, 126 may extend beyond the second surface 56 of the housing 52. When then electrical connector 50 is assembled with another electrical component 182, such as a printed circuit board or a substrate, proximate the second surface 56, the anchor tab 124 may be soldered to the component 182, as shown in FIG. 13. The anchor tab 124 may be soldered to the component 182 at the second portion 152, which may be flush against the component 182. The support member 70 may thereby help anchor the electrical connector 50 to the electrical component 182. Similarly, any of the anchor tabs of any of the support members may be soldered to the electrical component to help secure the electrical connector to the component. In one embodiment, all of the anchor tabs are soldered to the component.

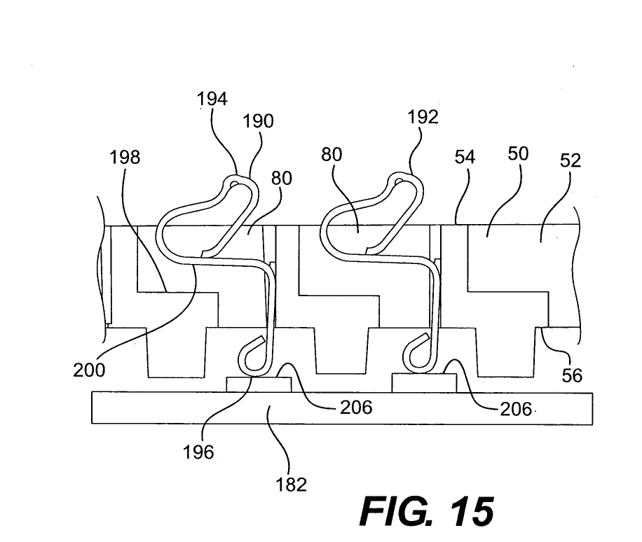

Referring to FIG. 15, the electrical contacts 190 of the electrical connector 50 may be disposed within the apertures 80 such that they extend beyond the first and second surfaces 54, 56. The electrical contacts 190 of the electrical connector 50 could be, for example, any of the appropriate contacts disclosed in U.S. Patent Publication No. 2007-0178719 A1 (U.S. patent application Ser. No. 11/634,593), which is incorporate herein by reference in its entirety. The contact 190 may include a first contact surface 194, which is disposed beyond the first surface 54 and a second contact surface 196, which is disposed beyond the second surface 56. The aperture 80 may include a shelf 198, over which a portion 200 of the contact 190 may extend. When the electrical connector 50 is assembled with another electrical component 182, the second contact surface 196 of the electrical contact 190 may make contact with a contact point, such as a contact pad 206, on the electrical component 182, to thereby establish an electrical connection. The second contact surface 196 may be soldered to the contact pad 206.

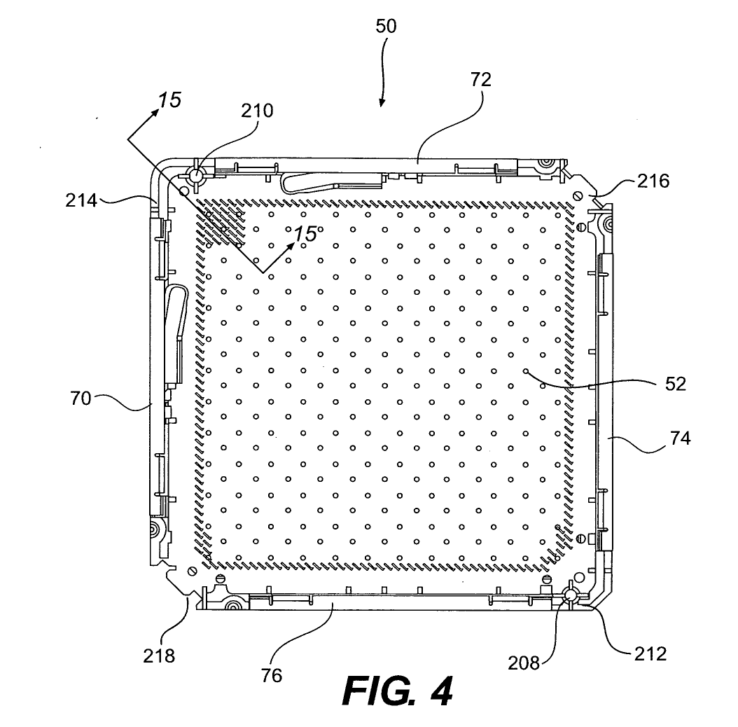

The support members may be useful in ensuring a substantially planar state in the housing in several circumstances. The housing may be molded in a molding process, which may cause the housing to be predisposed to bowing. The bow in the housing may cause the flatness profile may to be beyond the desired specifications. Referring to FIG. 4, the electrical connector 50 may include alignment pins 208, 210 disposed at the first and third corners 212, 214, which may be used to mount or align the connector 50 with another electrical component. When the alignment pins 208, 210 are engaged with another component, the unsecured second and fourth corners 216, 218 may have a tendency to rise upwards due to bowing of the housing 52. The electrical connector 50 could also be subject to various external forces which could cause deflection, bowing, or bending of the housing 52.

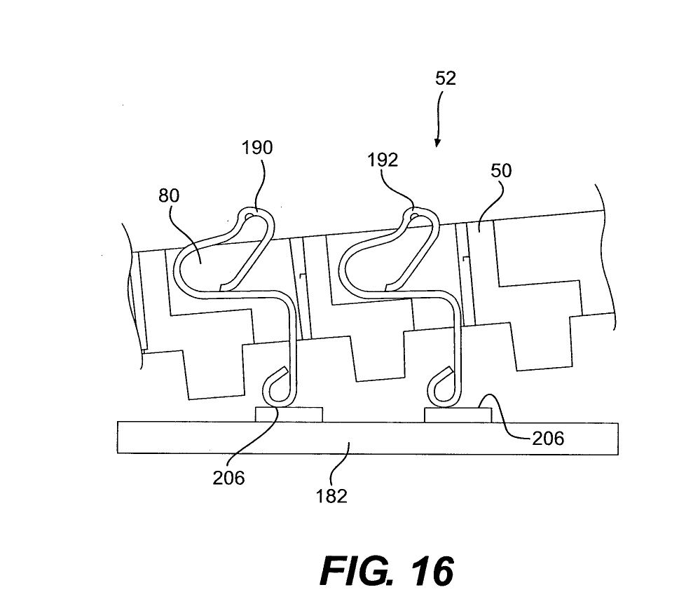

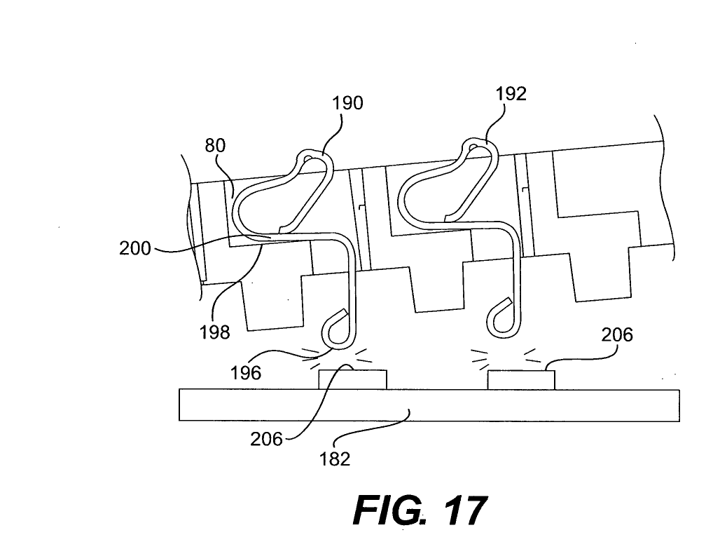

Referring to FIG. 16, when the housing 52 does not include the support members, the housing 52 may bow. As the housing 52 bows, the housing 52 may move relative to the contact 190, which may be in contact with another electrical component 182. The contact 190 may be soldered to the contact pad 206 on the electrical component 182. Referring to FIG. 17, if the housing 52 bows substantially enough, the shelf 198 of the aperture 80 may make contact with the portion 200 of the contact 190 and exert a force upon the contact 190. This force could cause the second contact surface 196 of the contact 190 to break contact with the contact pad 206 on the electrical component 182, thereby ending the electrical connection provided by the contact 190. If the upward force from the housing 52 on the contact 190 is sufficient, the contact 196 may break the solder connection between the second contact surface 196 and the contact pad 206. Such a situation can negatively impact the effectiveness of the electrical connector 50 to establish a desired electrical connection between electrical components.

Referring to FIG. 1, when the support members 70, 72, 74, 76 are mounted to the housing 52, the housing 52 may be substantially prevented from deflecting, bowing, or bending. Accordingly, the housing 52 may be maintained in a generally planar state, as shown in FIG. 15, wherein the contacts 190, 192 may be retained in a functioning position. The functionality of the electrical connector 50 is thereby better maintained.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Exemplary embodiments are described herein. Variations of those embodiments may become apparent to those of ordinary skill in the art upon reading the foregoing description. The inventor(s) expect skilled artisans to employ such variations as appropriate, and the inventor(s) intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An electrical connector comprising:
an insulative housing including a first surface, a second surface, a first side, and at least one aperture disposed from the first surface to the second surface; and
a support member mounted to the first side to provide rigidity to the insulative housing.

2. The electrical connector of claim 1 wherein the electrical connector further comprises an electrical contact disposed within the aperture for establishing electrical communication from the first surface to the second surface.

3. The electrical connector of claim 1 wherein the support member is stiffer than the insulative housing.

4. The electrical connector of claim 1 wherein the insulative housing is comprised of polymer and the support member is comprised of metal.

5. The electrical connector of claim 1 wherein the electrical connector includes a second support member, a third support member, and a fourth support member mounted to respective second, third, and fourth sides of the insulative housing.

6. The electrical connector of claim 5 wherein the support members constrain the insulative housing substantially within a single plane.

7. The electrical connector of claim 1 wherein the support member extends along a substantial length of the first side.

8. The electrical connector of claim 1 wherein the support member includes a first mounting latch.

9. The electrical connect of claim 1 wherein the support member includes a first anchor tab.

10. The electrical connector of claim 8 wherein the mounting latch is a clamping device configured to clamp onto the first side of the housing.

11. The electrical connector of claim 8 wherein the first mounting latch includes upper and lower tabs that are received by a first latch slot on the first surface of the housing and a second latch slot on the second surface of the housing, respectively, such that the tabs are retained therein to secure the support member to the first side.

12. The electrical connector of claim 11 wherein the support member includes a second mounting latch with upper and lower tabs received by third and fourth latch slots, respectively, on the insulative housing, wherein the first and second mounting latches are located on opposite first and second ends, respectively, of the support member.

13. The electrical connector of claim 1 wherein the support member includes a center beam that is substantially parallel with the first side, an upper wall that extends over the first surface of the housing, and a lower wall that extends over the second surface of the housing.

14. The electrical connector of claim 13 wherein the support member includes an anchor tab attached to the main beam, the anchor tab extending outside of the lower wall.

15. The electrical connector of claim 13 wherein the support member further includes a second mounting latch, the first and second mounting latches being disposed at first and second ends of the support member, respectively, and a second anchor tab, the first and second anchor tabs being disposed just inside the first and second mounting latches, the anchor tabs extending beyond the second surface of the insulative housing such that the lower wall is disposed between the anchor tabs and the mounting latches.

16. The electrical connector of claim 14 wherein the anchor tab is soldered to a component of an electrical assembly.

17. A support member for an electrical connector comprising:
a center beam,
a first mounting latch, the mounting latch including upper and lower tabs configured to be received by respective slots on an insulative housing of the electrical connector to mount the support member thereto.

18. The support member of claim 17 wherein the mounting latch is a clamping device.

19. The support member of claim 17 further comprising a second mounting latch including upper and lower tabs.

20. The support member of claim 17 wherein the upper and lower tabs converge towards each other as they extend away from the center beam.

21. The support member of claim 17 further comprising an upper wall and a lower wall that extend out substantially perpendicular to the center beam.

22. The support member of claim 17 further comprising an anchor tab attached to the main beam.

23. The support member of claim 22 wherein the anchor tab extends to the outside of the lower tab.
